(19) United States
(12) Patent Application Publication
(10) Pub. No.: US 2022/0200102 A1
(43) Pub. Date: Jun. 23, 2022

(54) FUSING BUS BAR FOR BATTERY MODULE TRANSPORTATION AND INSULATING CASE COMPRISING SAME

(71) Applicant: HYUNDAI MOBIS Co., Ltd., Seoul (KR)

(72) Inventor: Sang Chul JO, Geoje-si (KR)

(73) Assignee: HYUNDAI MOBIS Co., Ltd., Seoul (KR)

(21) Appl. No.: 17/550,527

(22) Filed: Dec. 14, 2021

(30) Foreign Application Priority Data
Dec. 23, 2020 (KR) 10-2020-0182677

(51) Int. Cl. H01M 50/505; H01M 50/517; H01M 50/583

(52) U.S. Cl. CPC H01M 50/505; H01M 50/583; H01M 50/517

(57) ABSTRACT

An insulating case includes a fusing bus bar electrically connected to one end of a battery module and a housing disposed between the battery module and the fusing bus bar to prevent the fusing bus bar from contacting an external object.

### CROSS-REFERENCE TO RELATED APPLICATION

This application claims the benefit under 35 USC § 119(a) of Korean Patent Application No. 10-2020-0182677, filed on Dec. 23, 2020 in the Korean Intellectual Property Office, the entire disclosure of which is incorporated herein by reference for all purposes.

### BACKGROUND

### 1. Field of the Invention

The present invention relates to a bus bar for battery module transportation and an insulating case comprising the same.

### 2. Discussion of Related Art

Generally, separate fuses are applied to batteries in units of systems to secure safety when a short circuit occurs.

Particularly, a battery using lithium, which has a large potential difference and high energy density with respect to a weight so that it is easy to reduce the weight thereof, has a high possibility of explosion or deformation even at a relatively low temperature according to an environment due to chemical characteristics thereof, and thus the battery needs to be handled with care.

Conventionally, since fuses are not applied in units of battery modules, transportation in units of battery modules is not possible. This is also because safety against a short circuit, which may occur when transportation is performed in units of battery modules, is not secured.

Accordingly, it is very inconvenient when transportation is required in units of battery modules.

### SUMMARY OF THE INVENTION

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an insulating case includes a fusing bus bar electrically connected to one end of a battery module and a housing disposed between the battery module and the fusing bus bar and configured to prevent the fusing bus bar from contacting an external object.

The housing may include a lower housing disposed under the fusing bus bar and having an open upper surface and an upper housing covering the open upper surface of the lower housing.

A section of the lower housing may divided by a partition in order to be insulated from a terminal block disposed at an opposite side of the lower housing not connected to the fusing bus bar.

The upper housing may have a grid structure on an upper surface thereof to allow a spark to escape when the battery module short-circuits.

The upper housing may be coupled to the lower housing in a snap-fit manner.

The upper housing may be coupled to the lower housing in a bolting manner.

The upper housing may be coupled to the lower housing in a sliding manner.

In another general aspect, an insulating case includes: a fusing bus bar electrically connected to one end of a battery module, a lower housing disposed between the battery module and the fusing bus bar and formed as a partition structure, and an upper housing covering an upper end of the lower housing and having an upper surface with a grid structure.

A portion of the upper housing in contact with the partition of the lower housing may be recessed.

A plurality of protrusions may be disposed along an outer circumferential surface of the lower housing and the protrusions may be spaced apart from each other, and the upper housing may include coupling grooves coupled to the protrusions in an engaging manner along an inner circumferential surface of the upper housing

In another general aspect, a fusing bus bar includes a base plate, a plurality of terminal parts disposed at both ends of the base plate, and a bent part disposed in a central portion between the plurality of terminal parts and including an inclined slit. One end of any one of the plurality of terminal parts has an end step structure protruding downward.

The base plate may be formed of a metal conductor that allows short-circuiting at a specific temperature.

Other features and aspects will be apparent from the following detailed description, the drawings, and the claims.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic view illustrating an insulating case according to one embodiment of the present invention;

FIG. 2 is a schematic exploded perspective view illustrating the insulating case according to one embodiment of the present invention;

FIG. 3 is a schematic plan view illustrating the insulating case according to one embodiment of the present invention;

FIG. 4 is a partially enlarged view schematically illustrating the insulating case according to one embodiment of the present invention; and

FIG. 5 is a view illustrating a fusing bus bar according to one embodiment of the present invention.

### DETAILED DESCRIPTION OF EXEMPLARY EMBODIMENTS

Advantages and features of the present invention and methods of achieving the same will be clear with reference to the accompanying drawings and the following detailed embodiments. However, the present invention is not limited to the embodiments to be disclosed below but may be implemented in various different forms, the embodiments are provided in order to fully explain the present invention and fully explain the scope of the present invention for those skilled in the art, and the scope of the present invention is defined by the appended claims. Meanwhile, the terms used herein are provided to describe embodiments of the present invention and not for purposes of limitation. In the specification, unless the context clearly indicates otherwise, the singular forms include the plural forms. The terms “comprise” or “comprising” used in the specification specify some stated components, steps, operations and/or elements but do not preclude the presence or addition of one or more other components, steps, operations and/or elements.

Hereinafter, the exemplary embodiments of the present invention will be described in detail with reference to the accompanying drawings.

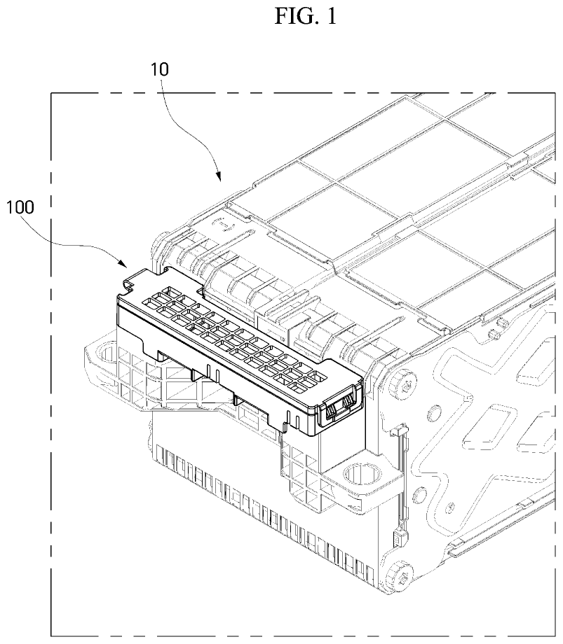

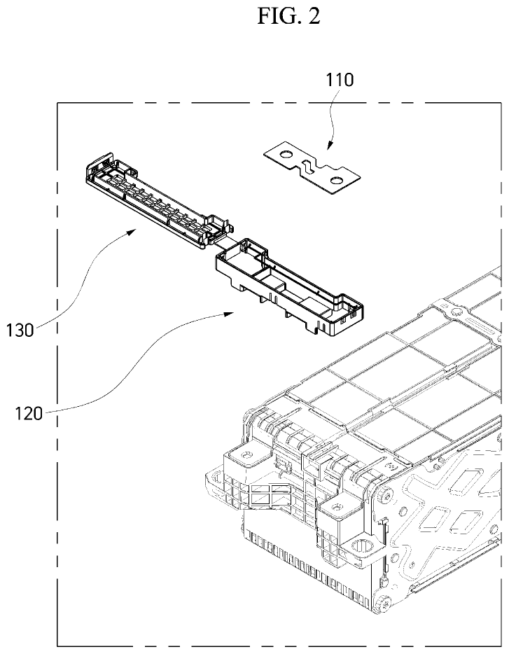

FIG. 1 is a schematic view illustrating an insulating case according to one embodiment of the present invention, and FIG. 2 is a schematic exploded perspective view illustrating the insulating case according to one embodiment of the present invention.

According to FIGS. 1 and 2, an insulating case 100 according to one embodiment of the present invention includes a fusing bus bar 110, a lower housing 120, and an upper housing 130.

The fusing bus bar 110 is electrically connected to one end of a battery module 10. The fusing bus bar 110 is a component to secure safety against a short circuit when the battery module 10 is transported in units of battery modules 10.

The fusing bus bar 110 has a structural feature that, when the battery module 10 is transported, the fusing bus bar 110 is bolted to an end portion of the battery module 10, and when the battery module 10 is completely transported, the fusing bus bar 110 is collected and recycled after separation therefrom.

The lower housing 120 is disposed between the battery module 10 and the fusing bus bar 110. The lower housing 120 has a structure of which an upper surface is open and sections are divided by partitions.

In this case, in the lower housing 120, a part of a section is divided by the partition in order to be insulated from a terminal block disposed at an opposite side which is not connected to the fusing bus bar 110. The lower housing 120 is formed as a structure in which upper and lower portions communicate with each other for each section of a floor.

A plurality of protrusions may be formed to be spaced apart from each other along an outer circumferential surface of the lower housing 120. In this case, the upper housing 130 may include coupling grooves (not shown) which are coupled to the protrusions of the lower housing 120 in an engaging manner and disposed along an inner circumferential surface thereof.

The upper housing 130 covers the open upper surface to the lower housing 120. The upper housing 130 has a grid structure on an upper surface thereof to allow sparks to escape easily when the battery module 10 short-circuits.

The upper housing 130 may be coupled to the lower housing 120 in a snap-fit manner. As another example, the upper housing 130 may be coupled to the lower housing 120 in a bolting manner. As still another example, the upper housing 130 may also be coupled to the lower housing 120 in a sliding manner.

A portion of the upper housing 130 in contact with the partition of the lower housing 120 may be formed to be recessed.

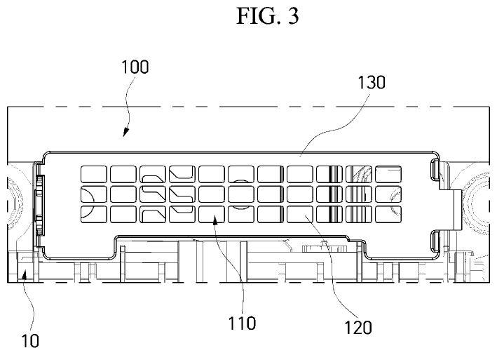

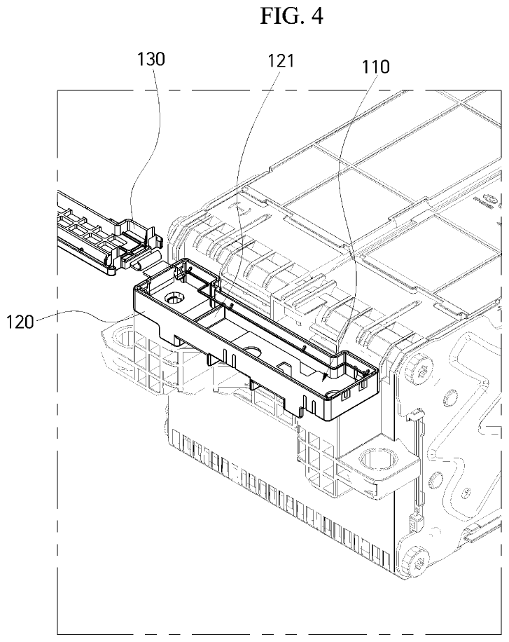

FIG. 3 is a schematic plan view illustrating the insulating case according to one embodiment of the present invention, and FIG. 4 is a partially enlarged view schematically illustrating the insulating case according to one embodiment of the present invention.

Referring to FIGS. 3 and 4, the upper housing 130 has the grid structure on the upper surface thereof. In this case, sizes of spaces in a grid of the upper housing 130 are small enough that a human finger cannot come into contact therewith. The spaces in the gird are formed as a casing structure through which the sparks escape when the battery module 10 short-circuits.

A structure of the partition 121 of the lower housing 120 is for securing an insulation distance from the terminal block disposed at the opposite side. This is because a risk of a short circuit of the battery module 10 is considered in a viewpoint of design.

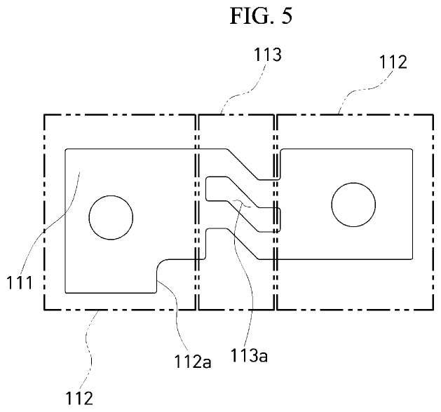

FIG. 5 is a view illustrating the fusing bus bar according to one embodiment of the present invention.

In FIG. 5, an overall form of the fusing bus bar 110 is designed to have a minimum thickness and a minimum area in consideration of only safety against a short circuit when the battery module is transported.

The fusing bus bar 110 includes a base plate 111, terminal parts 112, and a bent part 113.

The base plate 111 has a basic form of the fusing bus bar 110 and has a thickness of 0.8 T.

The terminal parts 112 are positioned at both ends of the base plate 111. Bolting holes coupled in a bolting manner are formed in sections thereof.

An end step 112a protruding downward is formed at a lower end of one of the plurality of terminal parts 112.

The bent part 113 is positioned in a central portion between the plurality of terminal parts 112. The bent part 113 includes an inclined slit 113a.

The fusing bus bar 110 may be formed of a metal conductor capable of short-circuiting at a specific temperature. A fusing function of the battery module is secured using the fusing bus bar 110 so that air transportation in units of modules may be performed.

According to the present invention, safety in units of battery modules can be secured, and transportation in units of modules is allowed at the same time by applying a fusing bus bar to a battery module.

Accordingly, air transportation in units of battery modules is allowed so that an after-sales service (A/S) cost and all costs related to transportation can be reduced.

The present invention is not limited to the embodiment described above and can be variously modified within a range allowed by the technical sprit of the present invention.

What is claimed is:

1. An insulating case comprising:
a fusing bus bar electrically connected to one end of a battery module; and
a housing disposed between the battery module and the fusing bus bar and configured to prevent the fusing bus bar from contacting an external object.

2. The insulating case of claim 1, wherein the housing includes:
a lower housing disposed under the fusing bus bar and having an open upper surface; and
an upper housing covering the open upper surface of the lower housing.

3. The insulating case of claim 2, wherein a section of the lower housing is divided by a partition in order to be insulated from a terminal block disposed at an opposite side of the lower housing not connected to the fusing bus bar.

4. The insulating case of claim 2, wherein the upper housing has a grid structure on an upper surface thereof to allow a spark to escape when the battery module short-circuits.

5. The insulating case of claim 2, wherein the upper housing is coupled to the lower housing in a snap-fit manner.

6. The insulating case of claim 2, wherein the upper housing is coupled to the lower housing in a bolting manner.

7. The insulating case of claim 2, wherein the upper housing is coupled to the lower housing in a sliding manner.

8. An insulating case comprising:
a fusing bus bar electrically connected to one end of a battery module;
a lower housing disposed between the battery module and the fusing bus bar and formed as a partition structure; and
an upper housing covering an upper end of the lower housing and having an upper surface with a grid structure.

9. The insulating case of claim 8, wherein, a portion of the upper housing in contact with the partition of the lower housing is recessed.

10. The insulating case of claim 8, wherein
a plurality of protrusions is disposed along an outer circumferential surface of the lower housing and the protrusions are spaced apart from each other; and
the upper housing includes coupling grooves coupled to the protrusions in an engaging manner along an inner circumferential surface of the upper housing

11. A fusing bus bar comprising:
a base plate;
a plurality of terminal parts disposed at both ends of the base plate; and
a bent part disposed in a central portion between the plurality of terminal parts and including an inclined slit,
wherein one end of any one of the plurality of terminal parts has an end step structure protruding downward.

12. The fusing bus bar of claim 11, wherein the base plate comprises a metal conductor that allows short-circuiting at a specific temperature.
